(19) United States
(12) Patent Application Publication
(10) Pub. No.: US 2026/0001494 A1
(43) Pub. Date: Jan. 1, 2026

(54) VEHICLE FOLDABLE LAPTOP STAND

(71) Applicant: YUN SEOK SHIN, Hwaseong (KR)

(72) Inventor: YUN SEOK SHIN, Hwaseong (KR)

(21) Appl. No.: 19/184,015

(22) Filed: Apr. 21, 2025

(30) Foreign Application Priority Data
Jun. 27, 2024 (KR) 10-2024-0084133

(51) Int. Cl. B60R 11/02; B60R 11/00

(52) U.S. Cl. CPC B60R 11/0252; B60R 2011/0005; B60R 2011/0082

(57) ABSTRACT

Disclosed is a vehicle foldable laptop stand including a base section, a support section, and a handle clamping section, wherein the base section includes a pair of base parts, front and rear support members, and a pair of upper and lower link members, the support section includes a pair of support parts and a pair of support pieces, and the handle clamping section includes a pair of shaft assembly pieces, a pair of fixed clamps, and a pair of steering wheel rear surface support pieces. A width between the base parts is adjusted by rotating the upper and lower link members and rivet shaft pins, the support pieces are pressed against a dashboard while the support parts are placed inside a lower portion of a steering wheel, and the fixing clamps contact the front surface of the steering wheel, thereby fixedly installing the foldable laptop stand on the steering wheel.

### TECHNICAL FIELD

The present invention relates to a vehicle laptop stand, and more particularly, to a vehicle foldable laptop stand configured to be readily and stably mounted on a steering wheel while a vehicle is stationary, to place a laptop on the vehicle foldable laptop stand in various forms depending on the sitting posture of a user, to be smoothly folded upwards in a state in which the laptop is placed on the vehicle foldable laptop stand so as to allow the user to exit the vehicle, to be readily folded for storage thereof after use of the laptop, and to provide a convenient installation process, thereby maximally improving portability and convenience of use of the vehicle foldable laptop stand.

### BACKGROUND OF THE INVENTION

The latest laptops capable of providing convenient portability may be used regardless of location. Particularly, the latest laptops may be used in the interior of a vehicle. When a driver wants to use a laptop in the interior of a vehicle, the driver stops driving and uses the laptop in a state in which the vehicle is stationary. Usually, the driver uses the laptop by placing the same on the lap while sitting on a vehicle seat.

However, in this case, since the driver needs to use the laptop while placing the laptop on the lap, the driver may feel uncomfortable in the vehicle. Further, when the laptop is placed on the lap of the driver, the laptop may not be stably fixed on the lap. Accordingly, the laptop may shake or unwanted may move in an direction, causing insufficient placement stability.

In addition, it is difficult to install a laptop stand in the vicinity of the driver's seat due to a steering wheel located adjacent to the driver's seat. Therefore, in a state in which a vehicle is stationary, the driver may use the laptop while placing the laptop on the steering wheel, or may excessively twist the body or may adjust a distance between the driver's seat and the steering wheel so as to use the laptop at a space away from the steering wheel. As a result, this bad posture of the driver may cause an increase in fatigue.

Therefore, in order for the driver to use the laptop conveniently in the correct posture, it is necessary to install a laptop stand capable of being easily attached to and detached from the steering wheel. In addition, in order to secure safe driving, there is demand for a laptop stand capable of being quickly removed from the steering wheel during the use of the laptop.

Here, Patent Document 1 discloses a “laptop stand detachably mounted on a steering wheel”.

Meanwhile, the laptop stand disclosed in Patent Document 1 may not be mounted on a steering wheel depending on various types of steering wheels, leading to deterioration in compatibility. For example, when the laptop stand disclosed in Patent Document 1 is mounted on the steering wheel, a mounting hook formed on the upper end of a vertical rod of the laptop stand is fitted to the steering wheel. In this case, the laptop stand may not be stably placed on the steering wheel depending on a difference in the diameter of the steering wheel. Further, a mounting plate configured for the laptop to be mounted thereon has limited angle adjustment and does not sufficiently support the laptop. Therefore, there is a disadvantage in that the mounting angle of the laptop mounted on the laptop stand may not be reliably maintained. In addition, when the driver wants to exit the vehicle while using the laptop mounted on the laptop stand, the laptop stand needs to be folded upwards, or when the driver enters the vehicle and wants to use the laptop, the laptop stand needs to be unfolded, which causes inconvenience to the driver.

Furthermore, since the laptop stand disclosed in Patent Document 1 does not provide a means for preventing slippage of the laptop placed on the laptop stand at the adjusted angle, the laptop may slip from the laptop stand when the angle of the mounting plate is large, which causes inconvenience to the driver working with the laptop in the vehicle.

### RELATED ART DOCUMENT

### Patent Document

(Patent Document 1) Korean Patent No. 10-0832226 (registered on May 19, 2008)

### SUMMARY OF THE INVENTION

Therefore, the present invention has been made in view of the above-described problems.

It is an object of the present invention to provide a vehicle foldable laptop stand configured to be readily foldable to reduce the size of the vehicle foldable laptop stand and improve storage thereof after use of a laptop, and to be quickly unfolded and mounted on a steering wheel in a state in which a vehicle is stationary when a driver needs to work with the laptop, thereby maximally improving convenience of use.

It is another object of the present invention to provide a vehicle foldable laptop stand configured to be readily mounted on a steering wheel regardless of a type of vehicle, to quickly perform angle adjustment depending on a type of laptop so as to prevent the laptop from slipping off of the vehicle foldable laptop stand, thereby maximally improving reliability.

It is a further object of the present invention to provide a vehicle foldable laptop stand configured to maximally improve convenience of use by enabling the vehicle foldable laptop stand to be quickly folded when a driver exits a vehicle.

In accordance with the present invention, the above and other objects can be accomplished by the provision of a vehicle foldable laptop stand detachably mounted on a steering wheel installed on a dashboard of a vehicle, the vehicle foldable laptop stand including a base section including a pair of base parts, front and rear support members, a pair of upper link members, and a pair of lower link members, wherein each of the base parts is formed of aluminum and is made by industrial injection molding, wherein the front and rear support members are installed to overlap each other and are disposed between the pair of base parts, wherein the upper link members respectively have one sides disposed to face each other, the one sides being disposed between upper portions of the front and rear support members and assembled with the upper portions so as to be axially rotatable around respective rivet shaft pins provided between the upper portions of the front and rear support members, and the other sides respectively disposed at upper portions of the base parts and assembled with the upper portions so as to be axially rotatable around respective rivet shaft pins provided at the upper portions of the base parts, wherein the lower link members respectively have one sides disposed between lower portions of the front and rear support members and assembled with the lower portions so as to be axially rotatable around respective rivet shaft pins provided between the lower portions of the front and rear support members, and the other sides respectively disposed at lower portions of the base parts and assembled with the lower portions so as to be axially rotatable around respective rivet shaft pins provided at the lower portions of the base parts, and wherein the base section is configured to adjust a width between the base parts through the upper link members and the lower link members, a support section including a pair of support parts and a pair of support pieces, wherein the support parts are folded upwards so as to be placed on the respective base parts through axial rotation thereof and are assembled with the respective base parts using setting shaft bolts configured to pass through shaft holes respectively formed in shaft bosses integrally protruding from upper portions of the respective base parts and shaft holes respectively formed in shaft bosses of the support parts, wherein the shaft holes formed in the support parts are disposed opposite the shaft holes formed in the base parts, and wherein the support pieces are respectively assembled with upper portions of the support parts using respective rivet shaft pins and are rotated 90 degrees inwards in an opposite direction, and a handle clamping section including a pair of shaft assembly pieces, a pair of fixed clamps, and a pair of steering wheel rear surface support pieces, wherein the shaft assembly pieces are formed to integrally protrude from the respective shaft bosses of the base parts, wherein the fixed clamps are screwed to the respective shaft assembly pieces and are configured for pressure plates to be detachably assembled with respective tips thereof, and wherein the steering wheel rear surface support pieces are respectively assembled with storage holes through respective shaft pins, the storage holes being formed to pass through the respective support parts.

The pair of upper link members and the pair of lower link members may be disposed between the front and rear support members and may respectively have sector gears respectively formed at end portions thereof, and the sector gears may be axially assembled with each other in a state of being engaged with each other so as to fix an unfolded state of the pair of base parts through angle setting.

The pair of base parts may include first and second storage holes formed to pass through respective lower portions of the base parts, the first and second storage holes being provided in two rows, and first and second support rods respectively assembled with the first and second storage holes with respective shaft pins, the first and second support rods being formed to protrude 90 degrees, wherein the pair of base parts may be configured to support a lower edge surface of a laptop body through rotation of the first and second support rods by 90 degrees.

The pair of support parts may have laptop support pieces formed to be integrated with the respective shaft bosses, the laptop support pieces being formed to protrude 90 degrees from the respective shaft bosses so as to support a lower edge surface of a laptop body.

### BRIEF DESCRIPTION OF THE DRAWINGS

The above and other objects, features, and other advantages of the present invention will be more clearly understood from the following detailed description taken in conjunction with the accompanying drawings, in which:

FIG. 1 is a perspective view of the present invention in a folded state;

FIG. 2 is a perspective view of the present invention in an unfolded state;

FIG. 3 is a partially exploded perspective view of components of the present invention;

FIG. 4 is a perspective view showing a state in which a width between base parts respectively disposed on opposite sides of a base section is adjusted to enter the unfolded state when the present invention is used;

FIG. 5 is a front view showing the steps of adjusting the width between the base parts respectively disposed on the opposite sides of the base section shown in FIG. 4 and entering the unfolded state;

FIGS. 6A-6C show a state in which support parts of a support section are unfolded when the present invention is used, in which:

FIG. 6A is a perspective view,

FIG. 6B is a front view, and

FIG. 6C is a photograph showing a state in which the support parts are installed on a steering wheel of a vehicle;

FIGS. 7A-7E show a state in which the base section is maximally unfolded and support pieces of the support section are unfolded when the present invention is used, in which:

FIG. 7A is a perspective view,

FIG. 7B is a front view,

FIG. 7C is a photograph showing a state in which a steering wheel rear surface support piece of a steering wheel clamping section is rotated to protrude and closely contact the rear surface of the steering wheel,

FIG. 7D is a photograph showing a state in which the steering wheel clamping section is clamped to the steering wheel while a support piece of the support part is in close contact with the lower surface of a dashboard of the vehicle, and

FIG. 7E is a photograph showing an installation state of the base section in a state in which the steering wheel clamping part is clamped to the steering wheel;

FIGS. 8A-8C show a way of using the present invention, in which:

FIG. 8A is a photograph showing a state in which a laptop and a keyboard are used by being placed on the present invention,

FIG. 8B is a photograph showing a state in which a laptop is used by being placed on the present invention, and

FIG. 8C is a photograph showing a state in which a laptop and a table are placed on the present invention, and a keyboard and a mouse are used on the table;

FIGS. 9A and 9B show a state in which the base parts of the base section according to the present invention are folded upwards, in which:

FIG. 9A is a perspective view of the folded base parts, and

FIG. 9B is a photograph showing a folded state of the base parts in a state which the laptop is placed on the present invention;

FIG. 10 is a perspective view of another embodiment of the present invention; and

FIG. 11 is a plan view of FIG. 10.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

In the description of the present invention, the structure and size of the components shown in the drawings may be simplified as long as the simplified drawings do not cause a problem in the description of the invention.

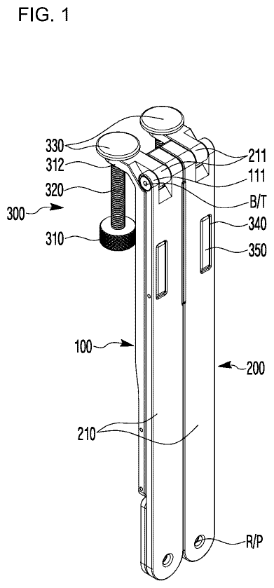

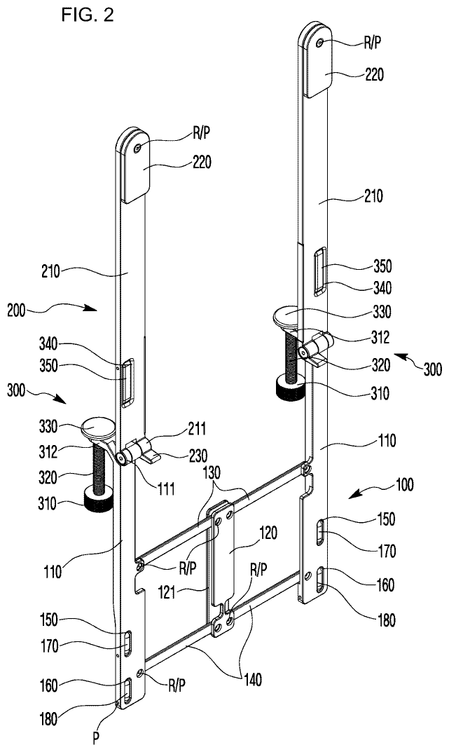

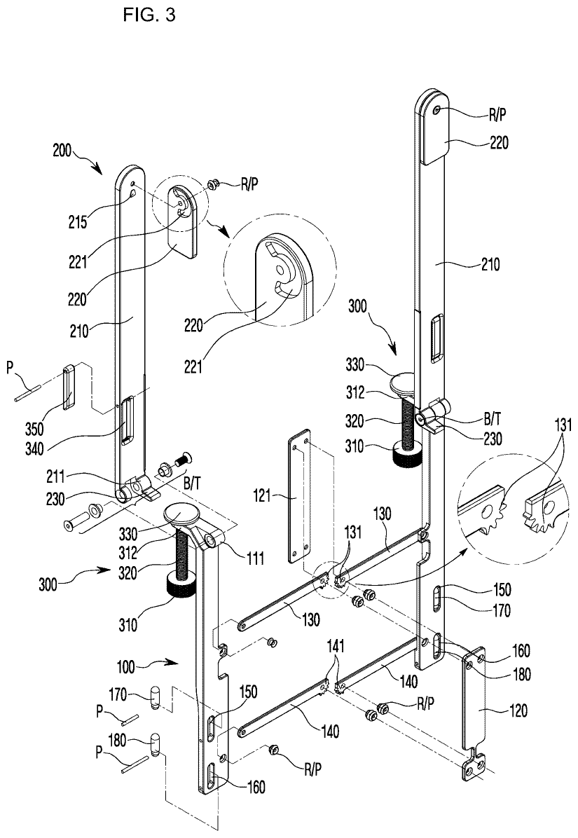

FIG. 1 is a perspective view of the present invention in a folded state, FIG. 2 is a perspective view of the present invention in an unfolded state, and FIG. 3 is a partially exploded perspective view of components of the present invention.

Referring to the drawings, a vehicle foldable laptop stand of the present invention is largely divided into a base section 100, a support section 200 folded at the base section, and a steering wheel clamping section 300 that fixes the unfolded state of the base section 100 and the support section 200.

According to the present invention, components are manufactured through injection molding using an aluminum material. The foldable laptop stand is stored in the folded and assembled state. The foldable laptop stand is unfolded and is used in a state of being placed on a steering wheel 10 of a vehicle and a dashboard 20 on which the steering wheel is installed.

The base section 100 is formed of a pair of base parts 110 and 110, front and rear support members 120 and 121 that overlap each other and are disposed between the pair of base parts, a pair of upper link members 130 and 130 respectively having one sides disposed to face each other, the one sides being disposed between upper portions of the front and rear support members and assembled to be axially rotatable around respective rivet shaft pins R/P provided between the upper portions of the front and rear support members, and the other sides respectively disposed at upper portions of the pair of base parts 110 and 110 and assembled to be axially rotatable around respective rivet shaft pins R/P provided at the upper portions of the pair of base parts 110 and 110, and a pair of lower link members 140 and 140 respectively having one sides disposed to face each other, the one sides being disposed between lower portions of the front and rear support members and assembled to be axially rotatable around respective rivet shaft pins R/P provided between the lower portions of the front and rear support members, and the other sides respectively disposed at lower portions of the pair of base parts 110 and 110 and assembled to be axially rotatable around respective rivet shaft pins R/P provided at the lower portions of the pair of base parts 110 and 110.

When the pair of base parts 110 and 110 is unfolded by a user in a state in which the user holds the base parts with both hands, the upper link members 130 and 130 and the lower link members 140 and 140 are rotated around the respective rivet pins R/P disposed between the front and rear support members 120 and 121 such that the base parts extends outwards in the horizontal direction, thereby adjusting a width between the base parts 110 and 110.

In this case, the upper link members 130 and 130 and the lower link members 140 and 140 are axially assembled in a state in which sector gears 131 and 131 respectively formed at the ends of the upper link members are engaged with each other, and sector gears 141 and 141 respectively formed at the ends of the lower link members are engaged with each other. In this manner, the unfolded state between the pair of base parts 110 and 110 is fixed at the angle set through the upper and lower link members.

Meanwhile, each of the base parts 110 and 110 includes first and second storage holes 150 and 160 formed to penetrate a corresponding one of the base parts and disposed on the lower side thereof in two rows, and first and second support rods 170 and 180 that are respectively assembled with the first and second storage holes 150 and 160 through respective shaft pins P and are formed to protrude 90 degrees through rotation thereof.

In this case, the rear inner side of each of the first and second storage holes 150 and 160 is formed to have a narrow through hole smaller than the outer diameter of each of the first and second support rods 170 and 180 so that each of the first and second support rods 170 and 180 rotatably protrudes 90 degrees in one direction. Specifically, a user may push the finger into the narrow through hole formed in each of the first and second storage holes 150 and 160 and may rotate a corresponding one of the first and second support rods 170 and 180 around a shaft pin P. In this manner, each of the first and second support rods 170 and 180 protrudes 90 degrees in the upward direction so as to support the lower edge surface of a laptop body.

The support section 200 incudes a pair of support parts 210 and 210 folded by upward rotation thereof around respective setting shaft bolts B/T in a state in which the support parts 210 and 210 are respectively assembled with the base parts 110 and 110 through the respective setting shaft bolts B/T that pass through respective shaft holes formed in shaft bosses 111 formed to integrally protrude from the upper portions of the base parts 110 and 110 and respective shaft holes formed in shaft bosses 211 opposite the respective shaft bosses 111, and a pair of support pieces 220 respectively assembled with the upper portions of the support parts 210 and 210 through respective rivet shaft pins R/P and configured to be rotated 90 degrees inwards in the opposite direction.

Here, each of the support pieces 220 and 220 includes a rotation restriction guide groove 221 formed in the inner side thereof, and a stopper protrusion 215 formed to protrude from each of the support parts 210 and 210. Inward rotation of each of the support pieces 220 around the rivet shaft pin R/P is restricted to 90 degrees when each of the support pieces is rotatably unfolded or folded.

The pair of support parts 210 and 210 is configured such that laptop support pieces 230 protrude in the direction of 90 degrees from the respective shaft bosses 211. In this manner, when the support parts 210 and 210 are unfolded, the lower edge surface of the laptop body may be supported by the protruding laptop support pieces 230, thereby preventing the laptop from slipping off of the laptop stand.

In the pair of base parts 110 and 110, the unfolding angle of the pair of support parts 210 and 210 is set by the steering wheel clamping section 300.

The steering wheel clamping section 300 includes shaft assembly pieces 312 formed to integrally protrude from the respective shaft bosses 111 of the base parts 110 and 110, fixed clamps 310 screwed to the respective shaft assembly pieces with screw rods 320 interposed therebetween, the fixed clamps being configured for respective pressure plates 330 to be detachably assembled with the tips of the screw rods 320, and a pair of steering wheel rear surface support pieces 350 and 350 respectively assembled with storage holes 340 through respective shaft pins P, the storage holes being formed to pass through the respective support parts 210 and 210. Here, each of the steering wheel rear surface support pieces is rotated 90 degrees in one direction.

The rear inner side of each of the storage holes 340 is formed to have a narrow through hole smaller than the outer diameter of each of the steering wheel rear surface support pieces 350 and 350 so that each of the steering wheel rear surface support pieces 350 and 350 rotatably protrudes 90 degrees in one direction. In this manner, a user may push a finger into the narrow through hole formed in each of the storage holes 340 and may rotate a corresponding one of the steering wheel rear surface support pieces 350 and 350 around the shaft pin P. In this manner, each of steering wheel rear surface support pieces 350 and 350 rotatably protrudes 90 degrees so as to support the rear surface of the steering wheel 10 of the vehicle.

The foldable laptop stand according to the present invention adjusts a width between the pair of base parts 110 and 110 by rotation of the pair of upper link members 130 and 130 and the pair of lower link members 140 and 140 through the respective rivet shaft pins R/P disposed between the front and rear support members 120 and 121. In a state in which the support parts 210 and 210 are unfolded through hinge rotation of the respective setting shaft bolts B/T and are maintained in the unfolded state, the support parts 210 and 210 are placed inside the lower portion of the steering wheel 10, and the support pieces 220 are unfolded to be in close contact with the lower portion of the dashboard 20. Thereafter, one side of each of the steering wheel rear surface support pieces 350 is pushed through a corresponding one of the storage holes 340 and is axially rotated to protrude downwards, and then each of the fixing clamps 310 is moved forwards through screw rotation so as to be in close contact with the front surface of the steering wheel 10. In this manner, the foldable laptop stand according to the present invention is fixedly installed on the steering wheel.

Hereinafter, the specific installation and operation according to the use of the foldable laptop stand will be described in detail.

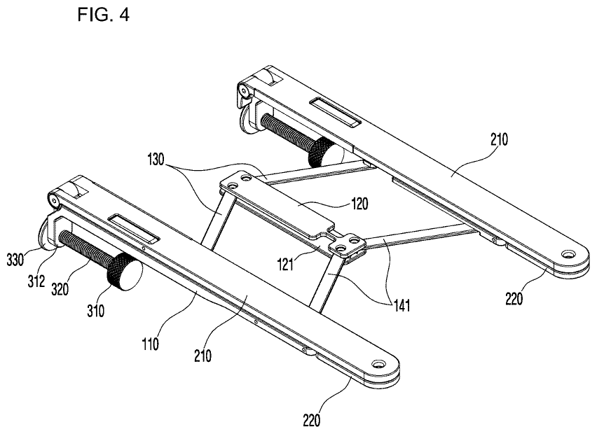

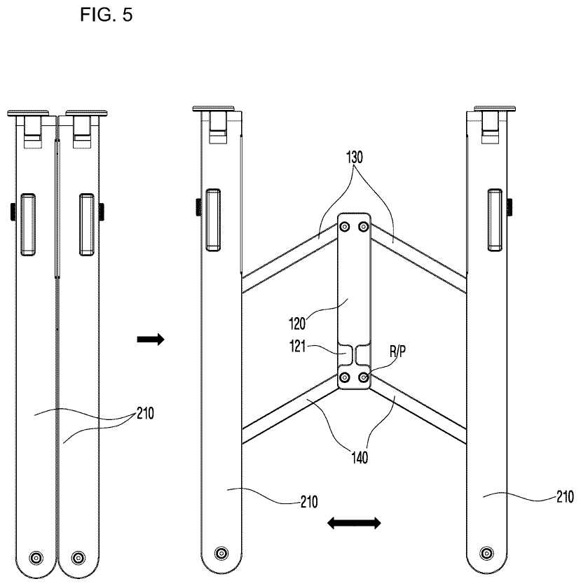

FIG. 4 is a perspective view showing a state in which a width between the base parts respectively disposed on opposite sides of the base section is adjusted to enter the unfolded state when the present invention is used, and FIG. 5 is a front view showing the steps of adjusting the width between the base parts respectively disposed on the opposite side of the base section shown in FIG. 4 and entering the unfolded state.

Referring to these drawings, in a state in which a vehicle is parked in a safe parking lot, when the base parts 110 and 110 respectively disposed on the opposite sides of the base section 100 are unfolded by a driver, the pair of upper link members 130 and 130 and the pair of lower link members 140 and 140 axially connected to the front and rear support members 120 and 121 through the respective rivet pins R/P are expanded in the horizontal direction through axial rotation such that a width between the base parts is increased by a predetermined interval.

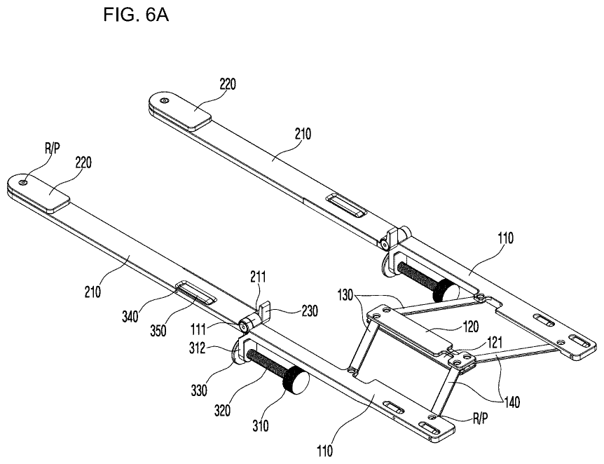

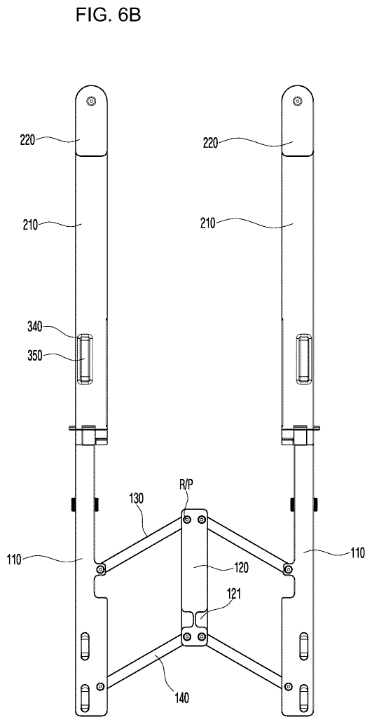

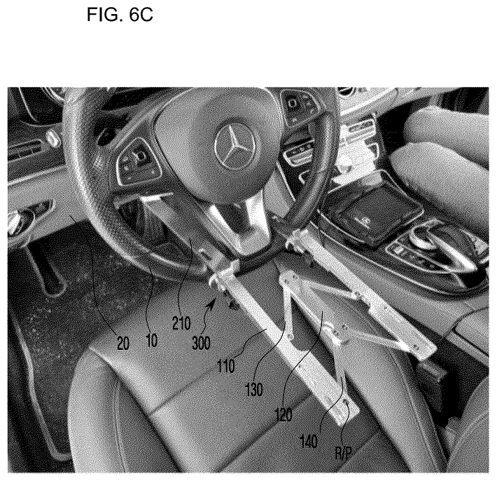

FIGS. 6A-6C show a state in which the support parts of the support section are unfolded when the present invention is used, FIG. 6A is a perspective view, FIG. 6B is a front view, and FIG. 6C is a photograph showing a state in which the support parts are installed on the steering wheel of the vehicle.

That is, as shown in FIGS. 4 and 5, after the pair of upper link members 130 and 130 and the pair of lower link members 140 and 140 are unfolded to increase a width between the base parts, the support parts 210 and 210 that are respectively disposed on the opposite sides of the support section 200 and are folded on the respective base parts 110 and 110 are unfolded through hinge rotation of the respective setting shaft bolts B/T.

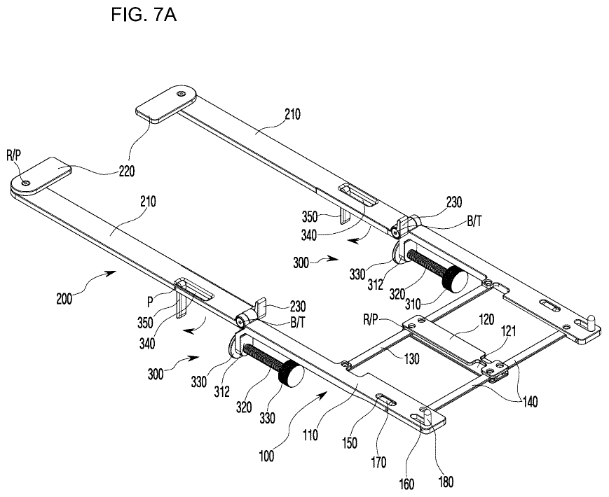

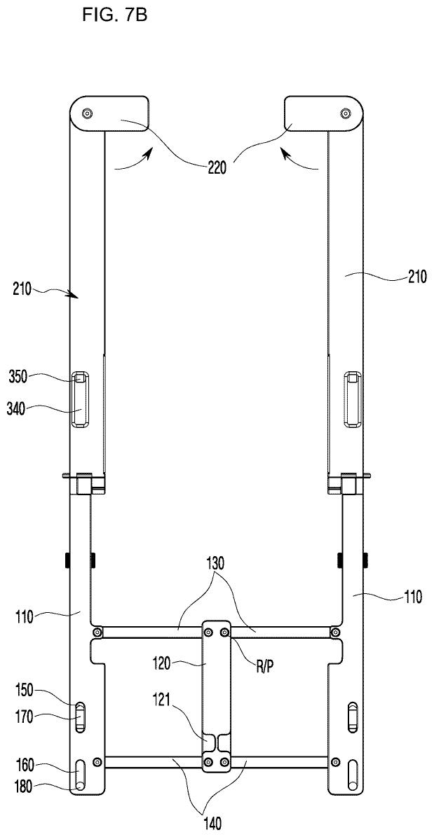

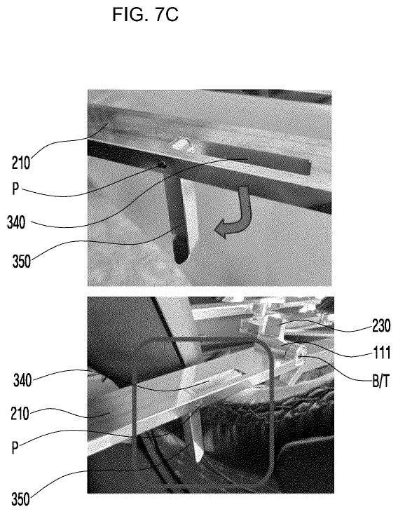

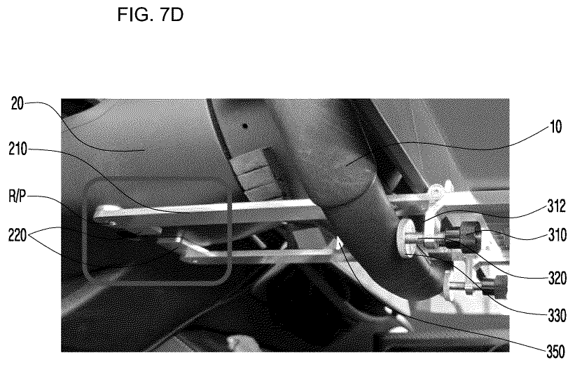

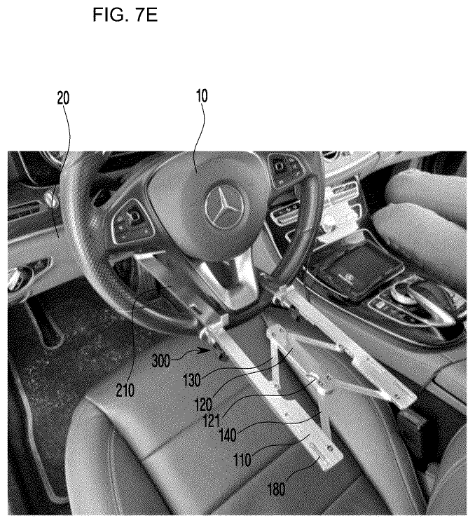

In this case, the pair of base parts 110 and 110 may be used by maximally increasing the width therebetween, as shown in FIGS. 7A and 7B.

In other words, the pair of base parts 110 and 110 may be appropriately unfolded to be aligned with the steering wheel 10.

FIGS. 7A-7E show a state in which the base parts of the base section are maximally unfolded and the support pieces of the support section are unfolded when the present invention is used, FIG. 7A is a perspective view, and FIG. 7B is a front view.

That is, the support parts 210 and 210 are placed at the lower portion of the steering wheel 10 of the vehicle in a state of being respectively unfolded from the base parts 110 and 110.

In this case, the support pieces 220, each of which is assembled with a corresponding one of the ends of the pair of support parts 210 and 210 through a corresponding one of the rivet pins R/P so as to be rotatable 90 degrees, are rotated inwards and are placed at the lower portion of the steering wheel 10 in the unfolded state thereof.

In this state, as shown in FIG. 7C, each of the steering wheel rear surface support pieces 350 of the steering wheel clamping section 300 is pushed through a corresponding one of the storage holes 340 and is rotated around the axial pin P, thereby protruding downwards and closely contacting the rear surface of the steering wheel 10.

In this state, as shown in FIG. 7D, in a state in which the support pieces 220 of the respective support parts 210 are in close contact with the lower surface of the dashboard 20 of the vehicle, the fixing clamps 310 are moved forwards from the front side of the steering wheel 10 by screw rotation of the screw rod 320 from the shaft assembly piece 312 so as to firmly attach the pressure plate 330 to the front side of the steering wheel 10, thereby completing installation of the foldable laptop stand, as shown in FIG. 7E.

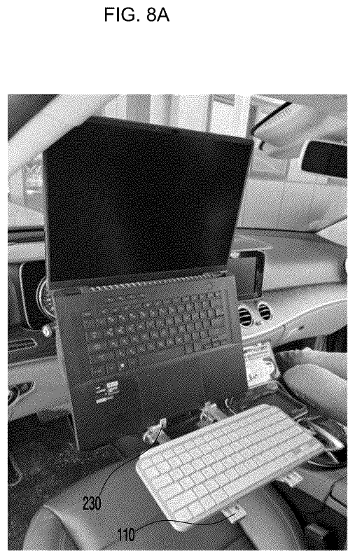

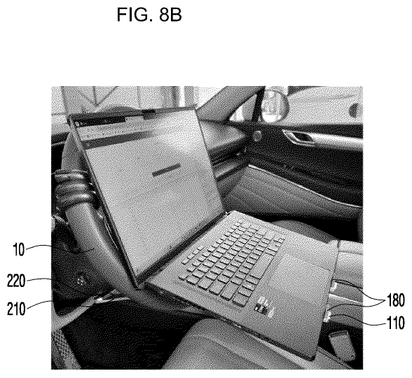

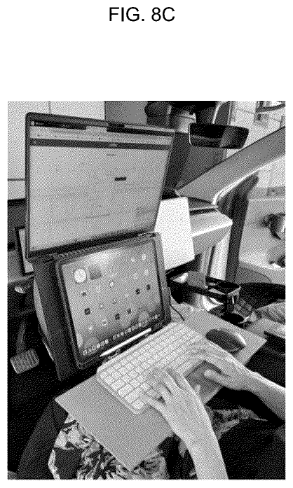

In this completed installation state, a laptop may be placed on the foldable laptop stand in various forms or may be placed on a table placed on the foldable laptop stand, as shown in FIGS. 8A-8C.

That is, as shown in FIG. 8A, a laptop and a keyboard may be placed on the foldable laptop stand, as shown in FIG. 8B, another laptop may be placed on the foldable laptop stand, and as shown in FIG. 8C, a laptop and a table may be placed on the foldable laptop stand, and a keyboard and mouse may be used on the table.

Further, the first and second support rods 170 and 180 of the first and second storage holes 150 and 160 respectively formed in the base parts 110 and 110 may selectively protrude upwards so as to support the lower edge surface of the laptop body, thereby preventing the laptop from slipping off of the foldable laptop stand. Additionally, in the pair of support parts 210 and 210, the lower edge surface of the laptop body may be supported by the laptop support pieces 230 protruding from the respective shaft bosses 211, thereby preventing the laptop from slipping off of the foldable laptop stand.

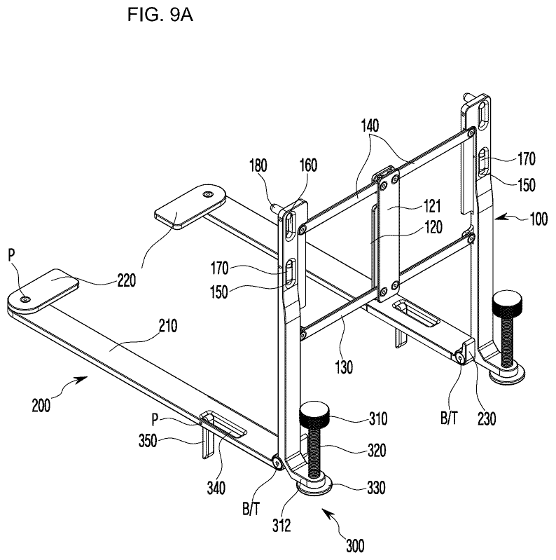

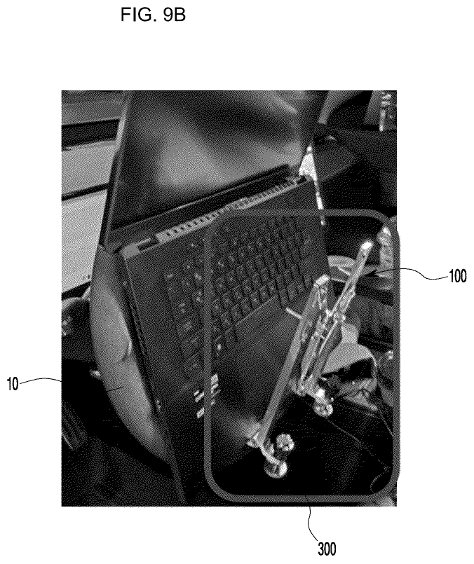

In addition, as shown in FIGS. 9A and 9B, when the driver exits the vehicle, the base parts 110 and 110 of the base section 100 may be folded upwards. Further, after the driver enters the vehicle, the base parts 110 and 110 may be used by unfolding the same downwards.

The embodiments according to the present invention have been described above. However, the present invention is not limited to the above-described embodiments, and may be implemented by various modifications without departing from the technical concept of the present invention.

For example, in the above-described embodiments, a width between the base parts may be increased by rotation of the upper and lower link members through the respective rivet shaft pins R/P disposed between the front and rear support members 120 and 121.

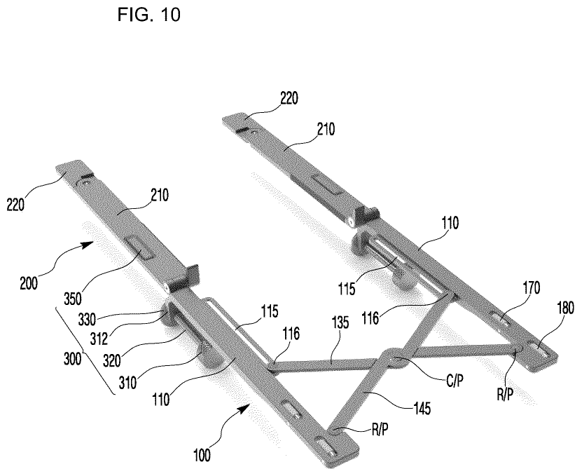

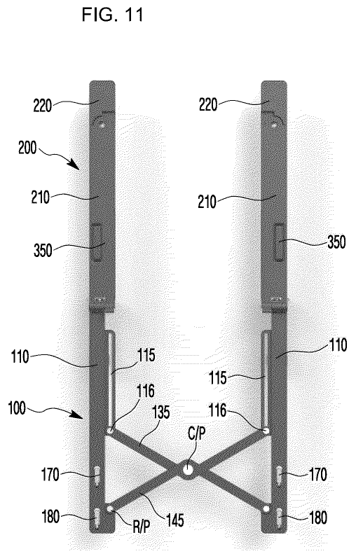

However, as shown in FIGS. 10 and 11, the base section 100 includes a pair of four-sided link members 135 and 145 formed to have an X-shape and axially assembled with each other through a center shaft pin C/P, in which the four-sided link members are disposed between the pair of base parts 110 and 110. The pair of four-sided link members 135 and 145 is assembled so that the upper end sides of the four-sided link members are slidably moved by guide shaft pins 116 respectively provided in guide slots 115 and 115 that are respectively formed in the upper sides of the pair of base parts 110 and 110 in a state of facing each other inwardly, and the lower end sides thereof are respectively connected to the lower sides of the pair of base parts 110 and 110 through the respective rivet shaft pins R/P.

In this embodiment, a width between the pair of base parts 110 and 110 may be increased or reduced by upward-and-downward movement of the four-sided link members 135 and 145 configured to be rotated with respect to the center shaft pin C/P and slidably moved by the guide shaft pins 116 along the respective guide slots 115 and 115 and X-shaped link movement by axial rotation of the rivet shaft pins R/P.

In addition, in the above-described embodiments, a material of the foldable laptop stand according to the present invention is not limited to a specific material. The foldable laptop stand according to the present invention is preferably formed of a lightweight material such as aluminum.

As is apparent from the above description, the present invention provides the following effects.

A foldable laptop stand according to the present invention may be quickly installed and removed regardless of the diameter or shape of steering wheels of various vehicles, thereby having an effect of securing compatibility and convenience of use.

In addition, the foldable laptop stand according to the present invention may be readily folded upwards in a state of being installed on the steering wheel of the vehicle when a driver exits a vehicle, thereby having an effect of securing convenience of use.

Further, the foldable laptop stand according to the present invention is formed of components made of aluminum, thereby having an effect of manufacturing the foldable laptop stand through injection molding for mass production, slimming down the foldable laptop stand, reducing the weight of the foldable laptop stand, and reducing manufacturing costs thereof.

Additionally, various types of laptops may be stably placed on the foldable laptop stand according to the present invention, thereby having an effect of preventing the laptop from slipping off of the foldable laptop stand.

Furthermore, the foldable laptop stand according to the present invention may be readily folded and stored in a storage portion after use.

Although specific embodiments have been described above in the detailed description of the invention, it is obvious that various modifications are possible without departing from the scope of the present invention. Therefore, the scope of the present invention should not be limited to the above-described embodiments, but should be defined not only by the claims described below but also by those equivalent to the claims.

What is claimed is:

1. A vehicle foldable laptop stand detachably mounted on a steering wheel installed on a dashboard of a vehicle, the vehicle foldable laptop stand comprising:
a base section comprising a pair of base parts, front and rear support members, a pair of upper link members, and a pair of lower link members, wherein each of the base parts is formed of aluminum and is made by industrial injection molding, wherein the front and rear support members are installed to overlap each other and are disposed between the pair of base parts, wherein the upper link members respectively have one sides disposed to face each other, the one sides being disposed between upper portions of the front and rear support members and assembled with the upper portions so as to be axially rotatable around respective rivet shaft pins provided between the upper portions of the front and rear support members, and the other sides respectively disposed at upper portions of the base parts and assembled with the upper portions so as to be axially rotatable around respective rivet shaft pins provided at the upper portions of the base parts, wherein the lower link members respectively have one sides disposed between lower portions of the front and rear support members and assembled with the lower portions so as to be axially rotatable around respective rivet shaft pins provided between the lower portions of the front and rear support members, and the other sides respectively disposed at lower portions of the base parts and assembled with the lower portions so as to be axially rotatable around respective rivet shaft pins provided at the lower portions of the base parts, and wherein the base section is configured to adjust a width between the base parts through the upper link members and the lower link members;
a support section comprising a pair of support parts and a pair of support pieces, wherein the support parts are folded upwards so as to be placed on the respective base parts through axial rotation thereof and are assembled with the respective base parts using setting shaft bolts configured to pass through shaft holes respectively formed in shaft bosses integrally protruding from upper portions of the respective base parts and shaft holes respectively formed in shaft bosses of the support parts, wherein the shaft holes formed in the support parts are disposed opposite the shaft holes formed in the base parts, and wherein the support pieces are respectively assembled with upper portions of the support parts using respective rivet shaft pins and are rotated 90 degrees inwards in an opposite direction; and
a handle clamping section comprising a pair of shaft assembly pieces, a pair of fixed clamps, and a pair of steering wheel rear surface support pieces, wherein the shaft assembly pieces are formed to integrally protrude from the respective shaft bosses of the base parts, wherein the fixed clamps are screwed to the respective shaft assembly pieces and are configured for pressure plates to be detachably assembled with respective tips thereof, and wherein the steering wheel rear surface support pieces are respectively assembled storage with holes through respective shaft pins, the storage holes being formed to pass through the respective support parts,
wherein the width between the pair of base parts is adjusted by rotating the pair of upper link members and the pair of lower link members through the respective rivet shaft pins disposed between the front and rear support members, the pair of support parts is unfolded by hinge rotation of the setting shaft bolts and is placed inside a lower portion of the steering wheel in a state of fixing an unfolded state of the pair of support parts, the respective support pieces are unfolded to be pressed against a lower portion of the dashboard, the steering wheel rear surface support pieces are pushed through the respective storage holes in one direction and are unfolded through axial rotation thereof, and the respective fixing clamps are moved forwards by screw rotation and are in close contact with a front surface of the steering wheel, thereby fixedly installing the vehicle foldable laptop stand on the steering wheel.

2. The vehicle foldable laptop stand according to claim 1, wherein the pair of upper link members and the pair of lower link members are disposed between the front and rear support members and have sector gears respectively formed at end portions thereof, and the sector gears are axially assembled with each other in a state of being engaged with each other so as to fix an unfolded state of the pair of base parts through angle setting.

3. The vehicle foldable laptop stand according to claim 1, wherein the pair of base parts comprises first and second storage holes formed to pass through respective lower portions of the base parts, the first and second storage holes being provided in two rows, and first and second support rods respectively assembled with the first and second storage holes with respective shaft pins, the first and second support rods being formed to protrude 90 degrees, wherein the pair of base parts is configured to support a lower edge surface of a laptop body through rotation of the first and second support rods by 90 degrees.

4. The vehicle foldable laptop stand according to claim 1, wherein the pair of support parts has laptop support pieces formed to be integrated with the respective shaft bosses, the laptop support pieces being formed to protrude 90 degrees from the respective shaft bosses so as to support a lower edge surface of a laptop body.

5. A vehicle foldable laptop stand detachably mounted on a steering wheel installed on a dashboard of a vehicle, the vehicle foldable laptop stand comprising:
a base section comprising a pair of base parts and a pair of four-sided link members disposed between the pair of base parts and axially assembled with each other in an X-shape through a center shaft pin, wherein each of the base parts is formed of aluminum and is made by industrial injection molding, wherein the four-sided link members have upper end sides assembled with respective guide shaft pins so as to be slidably moved along guide slots respectively formed in upper sides of the base parts, the guide slots being formed to face each other inwardly, and lower end sides axially assembled with respective lower sides of the base parts through respective rivet shaft pins, and wherein the base section is configured to adjust a width between the base parts through the four-sided link members;
a support section comprising a pair of support parts and a pair of support pieces, wherein the support parts are folded upwards so as to be placed on the respective base parts through axial rotation thereof and are assembled with the respective base parts using setting shaft bolts configured to pass through shaft holes respectively formed in shaft bosses integrally protruding from upper portions of the respective base parts and shaft holes respectively formed in shaft bosses of the support parts, wherein the shaft holes formed in the support parts are disposed opposite the shaft holes formed in the base parts, and wherein the support pieces are respectively assembled with upper portions of the support parts using respective rivet shaft pins and are rotated 90 degrees inwards in an opposite direction; and
a handle clamping section comprising a pair of shaft assembly pieces, a pair of fixed clamps, and a pair of steering wheel rear surface support pieces, wherein the shaft assembly pieces are formed to integrally protrude from the respective shaft bosses of the base parts, wherein the fixed clamps are screwed to the respective shaft assembly pieces and are configured for pressure plates to be detachably assembled with respective tips thereof, and wherein the steering wheel rear surface support pieces are respectively assembled with storage holes through respective shaft pins, the storage holes being formed to pass through the respective support parts,
wherein the width between the pair of base parts is adjusted by upward-and-downward movement of the four-sided link members configured to be rotated with respect to the center shaft pin C/P and slidably moved along the respective guide slots by the respective guide shaft pins, and X-shaped link movement by axial rotation of the rivet shaft pins, the pair of support parts is unfolded by hinge rotation of the setting shaft bolts and is placed inside a lower portion of the steering wheel in a state of fixing an unfolded state of the pair of support parts, the respective support pieces are unfolded to be pressed against a lower portion of the dashboard, the steering wheel rear surface support pieces are pushed through the respective storage holes in one direction and are unfolded through axial rotation thereof, and the respective fixing clamps are moved forwards by screw rotation and are in close contact with a front surface of the steering wheel, thereby fixedly installing the vehicle foldable laptop stand on the steering wheel.
